(19) United States
(12) Patent Application Publication
(10) Pub. No.: US 2026/0072161 A1
(43) Pub. Date: Mar. 12, 2026

(54) Machine-Learning Models for Integrated Video Capture and Annotation System

(71) Applicant: Matroid, Inc., Palo Alto, CA (US)

(72) Inventors: Reza Zadeh, Emerald Hills, CA (US); John Goddard, Mountain View, CA (US); Ryan Wong, Palo Alto, CA (US); Darin Tay, Palo Alto, CA (US); Andrew Ellison, Palo Alto, CA (US); Huaijin Wang, Palo Alto, CA (US); Moussa Haidous, Palo Alto, CA (US); Sanil Pande, Palo Alto, CA (US)

(21) Appl. No.: 18/827,490

(22) Filed: Sep. 6, 2024

(51) Int. Cl. G01S 13/88; G01V 5/26

(52) U.S. Cl. CPC G01S 13/887; G01V 5/26

(57) ABSTRACT

A system accesses a first video stream from an internal scanning device (e.g., an X-ray scanner) that scans objects or individuals. It also accesses a second video stream from a capturing device that records a human operator reviewing and interacting with the first stream on a display to identify targeted subject matter. The system then identifies the targeted subject matter based on the operator's interactions and constructs a training dataset based on the identified targeted subject matter. Using this training dataset, the system trains a machine-learning model to identify the targeted subject matter in future video streams from scanning devices.

### BACKGROUND

### 1. Field of the Disclosure

This disclosure relates generally to training and retraining machine-learned (ML) models, and more specifically to training and retraining ML models using training datasets that are generated based on human interactions with images.

### 2. Description of the Related Art

Proprietary imaging machines are specialized devices used in various fields like medicine, security, and industrial applications to capture images not typically visible to the naked eyes. These machines often employ advanced technologies to produce detailed images for diagnostics, security checks, and quality control. For example, MRI (Magnetic Resonance Imaging) machines use strong magnetic fields and radio waves to images of the organs and tissues within the body, which can help to identify conditions such as tumors, brain disorders, and spinal injuries.

Further, various types of X-ray scanners can be used for both medical purposes and security purposes. A CAT (Computerized Axial Tomography) scanner is a type of X-ray scanner that is primarily used in medical settings. A CAT scanner passes X-rays through a body to create detailed cross-sectional images, or slices, of the body. In some embodiments, the X-ray source and detectors rotate around the body, capturing multiple angles that a computer then uses to construct a 3D image of the internal structures.

A backscatter scanner is another type of X-ray scanner that can be used primarily for security screening of individuals, baggage, and/or vehicles at checkpoints or border crossings. Backscatter scanners emit low-energy X-rays that are directed toward the object or person being scanned. These X-rays are of such low energy that they do not pass through the body or object but instead, scatter back after hitting the surface or objects concealed on or near the body. The scattered X-rays are captured by detectors in the scanner, which then creates an image of the scanned individual or object based on the intensity of the backscattered rays. This image can show the contours of the body as well as objects that are hidden under clothing or in concealed compartments, including drugs, explosives, weapons, or even humans, hidden within vehicles, aiding in the identification of prohibited items.

Operators of these imaging machines often review the images or video streams manually to identify targeted subject matter. In some cases, upon identifying such subject matter, an operator can annotate the image by drawing a bounding box around the subject matter and/or assigning a label to this bounding box.

### SUMMARY

Proprietary imaging machines are specialized devices used in various fields like medicine, security, and industrial applications to capture images not typically visible to the naked eyes. However, such proprietary imaging machines can be challenging to work with primarily due to their specialized nature and the constraints imposed by proprietary technologies. For example, many proprietary machines operate as closed systems, meaning they do not readily share data with other systems. Embodiments described herein address the above-described problems by capturing both the raw images output from proprietary machines and human interactions with these images.

In some embodiments, a system accesses a first video output stream from an internal scanning device (e.g., an X-ray scanner) as the internal scanning device scans objects or people. The system captures a second video output stream from an image-capturing device configured to record a human operator as the human operator reviews the first video output stream displayed on a display and interacts with portions of the first video output stream to identify targeted subject matter, which in turn generates the second video output stream. The system identifies the targeted subject matter in the first video output stream based on interactions by the human operator and generates a training dataset based on the identified targeted subject matter and corresponding portions of images in the first or second video output stream. The system trains a machine-learned model using the generated training dataset. The ML model is trained to identify the targeted subject matter in video streams from the internal scanning device.

The trained machine-learning model may then be deployed onto an image-capturing device, which applies the ML model to a target video output stream to automatically identify targeted subject matter. A human operator can also interact with the target video stream, and the ML-detected targeted subject matter, such as confirming or rejecting detections made by the ML model, and identifying any additional targeted subject matter the ML model missed. The interaction data can be used to generate additional training datasets, which can then be used to retrain the ML model. The retrained ML model is then redeployed onto an image-capturing device to identify targeted subject matter automatically. A human operator can interact with the video stream and the newly detected targeted objects again, providing further data for ongoing retraining of the ML model.

This process can repeat multiple times as needed until the model's performance reaches a desired level. Alternatively, this training cycle can be scheduled to recur at regular intervals or triggered when a sufficient amount of interaction data is accumulated, ensuring continuous improvement of the ML model based on fresh data.

### BRIEF DESCRIPTION OF THE DRAWINGS

The teachings of the present disclosure can be readily understood by considering the following detailed description in conjunction with the accompanying drawings.

FIG. 1 is a block diagram of an overall system environment illustrating a media detection system providing media detection services, according to an embodiment.

FIG. 2A illustrates an example of a vehicle scanning system at a checkpoint, in accordance with one or more embodiments.

FIG. 2B illustrates an example X-ray scan of a vehicle in a top down view in accordance with one or more embodiments.

FIG. 3 illustrates an example architecture of an image-capturing device, in accordance with one or more embodiments.

FIG. 4 illustrates an example architecture of a cloud training system in accordance with one or more embodiments.

FIG. 5 illustrates a loop training process in accordance with one or more embodiments.

FIG. 6 is a flowchart of an example method for training an ML model based on tracking user interactions with images received from imaging systems, in accordance with one or more embodiments.

FIG. 7 is a flowchart of a method for retraining an ML model based on tracking user interactions with images received from imaging systems, in accordance with one or more embodiments.

FIG. 8 is a high-level block diagram of a computer for implementing different entities illustrated in FIG. 1.

### DETAILED DESCRIPTION

The Figures (Fig.) and the following description relate to various embodiments by way of illustration only. It should be noted that from the following discussion, alternative embodiments of the structures and methods disclosed herein will be readily recognized as viable alternatives that may be employed without departing from the principles discussed herein. Reference will now be made in detail to several embodiments, examples of which are illustrated in the accompanying figures. It is noted that wherever practicable similar or like reference numbers may be used in the figures and may indicate similar or like functionality.

Proprietary imaging machines are specialized devices employed in medicine, security, and other industries to capture images that are often invisible to the naked eye. These machines include MRI machines and X-ray scanners, among others. MRI machines use strong magnetic fields and radio waves to produce images of internal organs and tissues, aiding in diagnosing conditions like tumors and spinal injuries. X-ray scanners include CAT scanners and backscatter scanners. These X-ray scanners employ X-rays to generate images for medical or security applications, such as examining body parts, scanning baggage at airports, and/or inspecting entire vehicles at border crossings to detect hidden contraband like drugs and weapons, among others. Operators of these imaging machines often review the images or video streams manually to identify targeted subject matter. In some cases, upon identifying such subject matter, an operator can annotate the image by drawing a bounding box around the subject matter and/or assigning a label to this bounding box.

However, such proprietary imaging machines can be challenging to work with primarily due to their specialized nature and the constraints imposed by proprietary technologies. For example, many proprietary machines operate as closed systems, meaning they do not readily share data with other systems. This can make extracting, analyzing, or integrating data with other software or databases difficult. These machines often have limited or no Application Programming Interface (API) access, preventing third-party software from interacting directly with the machine. This restricts the ability to automate processes or integrate with other systems.

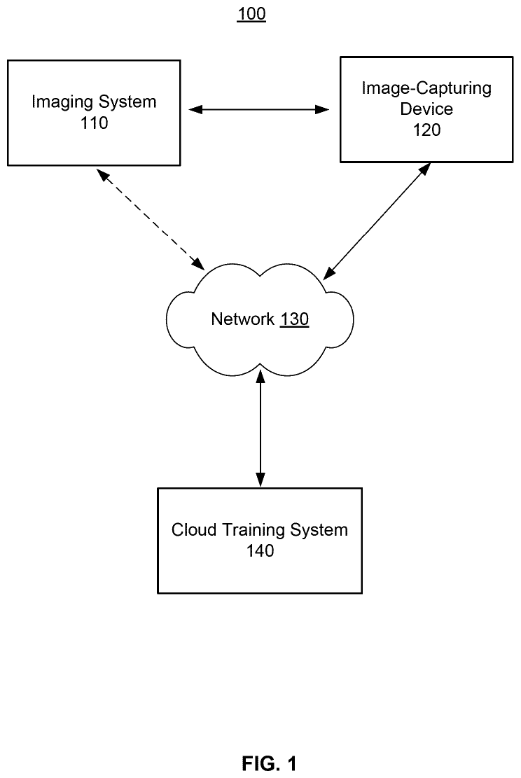

Embodiments described herein address the above-described problems by capturing both the raw images output from proprietary machines and human interactions with these images through a media transmission interface. Human interactions with these raw images are analyzed using machine learning (ML) techniques to train a model capable of automatically detecting objects that a human operator is likely to interact with. This model is then deployed on image-capturing devices that receive raw images output from the proprietary machines, automatically identifying targeted objects in the raw images in real time or near real time. The targeted objects detected by the model are annotated and displayed to the operators, who may interact with the images and the annotated objects. Such interactions help identify any false positives or negatives generated by the model, which can then be converted into training examples and used to retrain the model. This process establishes a training loop, enabling continuous improvement of the ML model based on training examples generated from ongoing operations. Additional details about this loop training process are further described below with respect to FIGS. 1-7.

### System Overview

FIG. 1 is a block diagram of an overall system environment 100, including an imaging system 110, an image-capturing device 120, and a cloud training system 140 configured to communicate with each other via a network 130 in accordance with one or more embodiments. The imaging system 110 is configured to generate media data, including images, videos, and/or audio data. The imaging system 110 may be a proprietary imaging machine that operates as a closed system, meaning it does not readily share data with other systems. In some embodiments, the imaging system 110 may be a border-crossing CAT scanner configured to scan vehicles, containers, and cargo to ensure security and compliance with custom regulations. Vehicles and containers can be driven through a scanning tunnel where a CAT scanner is used to capture cross-sectional images of their contents. These scanners can penetrate deep into the contents of a vehicle or container, revealing hidden compartments, and the contents within without the need for manual unpacking or invasive checks. In some embodiments, the imaging system 110 may be a medical imaging device, such as an MRI scanner, a CAT scanner, an X-ray scanner, or a back scatter scanner configured to scan human bodies to provide images of the inside of the human bodies.

The image-capturing device 120 is a computing system configured to receive the media data generated by the imaging system 110. In some embodiments, the image-capturing device 120 is coupled to the imaging system 110 with software installed thereon for communicating with the imaging system. In some embodiments, the image-capturing device 120 includes a media transmission interface configured to receive the raw media data generated by the imaging system 110 and present the received raw media data for display. In some embodiments, the images from the proprietary imaging machines are received as a video stream. A video stream is a sequence of moving images that are sent and/or displayed in near real time. Each of these moving images is referred to as a frame. In some embodiments, the video stream may be displayed to users. Alternatively, a frame or a subset of frames may be displayed to users. In some embodiments, users can select any one of the frames to be displayed.

The image-capturing device may be a specialized device or a generic computing device, for example, a mobile device (e.g., a laptop, a smart phone, or a tablet with operating systems such as Android or Apple IOS etc.), a desktop, a smart automobiles or other vehicles, wearable devices, a smart TV, and other network-capable devices.

In some embodiments, the image-capturing device 120 also includes a pretrained ML model trained to analyze the raw media data to identify targeted objects. The image-capturing device 120 may apply the ML model to each of the frames or a subset of the frames to detect targeted objects.

In scenarios like border crossings and medical imaging, ML models are trained to detect a variety of targeted objects relevant to each context. For example, in a border crossing case, the targeted objects may include (but are not limited to) illegal substances such as drugs, weapons, explosives, and other prohibited items. In some embodiments, ML models can also be trained to detect human figures in unexpected areas of vehicles, potentially identifying stowaways trying to cross borders illegally. In some embodiments, the ML models can also be trained to identify modifications to vehicles or containers that suggest the presence of hidden compartments designed to smuggle goods or persons. In a medical imaging case, ML models may be trained to identify and characterize tumors and cysts in various organs, helping in early diagnosis and treatment planning. In some embodiments, the ML models may also be trained to detect anatomical anomalies like congenital defects, vessel occlusions, or unexpected masses.

When the ML model detects targeted objects in the received media data, the model may highlight the targeted objects with bounding boxes around them on the image displayed at the image-capturing device 120. The bounding boxes may be color-coded based on a type of object or a level of threat they represent. In some embodiments, along with bounding boxes, labels or labels may be added to provide concise descriptions or classifications of the detected objects (e.g., weapon, tumor, fracture). In some embodiments, additional information, such as a confidence level of the detection or relevant metrics (size, density), can be overlaid near the detected object to aid in further analysis.

In some embodiments, users can interact with the detection annotations to get more detailed information. For example, clicking on a bounding box might open a detailed view or a summary of findings related to that particular object. In some embodiments, a user interface may further allow users to adjust or filter what types of detections are displayed, helping to manage clutter on the screen and focus on priority items. In some embodiments, the user can also interact with the detected objects by confirming or dismissing them. Such user interactions can be captured and used as additional training examples to retrain the ML models.

In some embodiments, the detected objects may also be integrated with other decision support tools within the image-capturing device 120, such as automatic reporting templates or further diagnostic tests. In some embodiments, the ML models may include a similarity model to identify and present past images or data related to a similar object, aiding in comparative analysis and decision-making. For high-priority detections, such as potential threats at a border crossing or critical medical conditions, the image-capturing device 120 can generate alerts or notifications to ensure immediate attention from the user. In some embodiments, users can customize alert settings based on their preferences or operational requirements, ensuring they receive relevant notifications without being overwhelmed.

In some embodiments, the image-capturing device 120 is also configured to compile detected objects and their annotations into reports, which can be reviewed, edited, and saved or printed for documentation or further analysis. In some embodiments, interactions with detected objects and decisions made by users are also logged, creating an audit trail that supports accountability and traceability.

The cloud training system 140 is configured to receive various data from the image-capturing device 120, such as user interactions with raw images generated by the imaging system 110. In some embodiments, an initial training dataset for an ML model may be created based on user interactions with raw images. The user interactions may include (but are not limited to) bounding box annotations, label assignments, attribute labeling, and/or segmentation masks, among others. Bounding box annotations may include (but are not limited to) users drawing bounding boxes (rectangles or other polygonal shapes) around targeted objects in images. In a border crossing security application, users might annotate images by drawing boxes around items like weapons or suspicious packages in luggage scans. Label assignments may include (but are not limited to) users assigning one of a plurality of predefined labels to specific objects or bounding boxes in an image. These labels categorize the targeted objects based on predefined classes. In the border crossing security application, users might assign a “weapon” label to a bounding box associated with a weapon, or assign a “drug” label to a bounding box associated with a drug. Attribute labeling may include (but is not limited to) labeling additional attributes or properties to objects or bounding boxes in the image, providing additional contextual information. For example, users may label a bounding box labeled with “weapon” with a confidence level, e.g., high, medium, or low. Segmentation masks may include (but are not limited to) creating a pixel-wise contour that segments a portion of the image. In medical imaging, medical professionals could segment regions of a tissue scan to differentiate between healthy and cancerous cells.

Such user interaction data may be collected and transmitted from the image-capturing device 120 to the cloud training system 140. The cloud training system 10 may extract features from the interaction data and generate training examples based on the extracted features. The training examples may then be used to train an ML model for object identification and/or classification. For example, in a border crossing security scenario, a first object classification model may be trained to detect weapons, a second object classification model may be trained to detect drugs, and so on and so forth. These trained models may then be deployed onto the image-capturing device 120. For a given image received from the imaging system 110, the ML models are trained to detect drugs, weapons, and other targeted objects that are prohibited from being transported across the border.

The users may interact with the targeted objects detected by the ML models and the raw images. Such interaction data may then be transmitted to the cloud training system 140, and used to generate additional training examples based on the received data. The ML models may then be retrained using the additional training examples. As described above, users may confirm or dismiss ML-detected targeted objects. In some cases, the users may also annotate additional targeted objects that are missed by the ML models. When users confirm or dismiss ML-detected objects, each action provides a label for the corresponding object. Confirmations validate the model's prediction, while dismissals indicate false positives. Users' additional annotations of objects that the ML model missed also provide examples of false negatives. These additional training examples are added to a training dataset, which can be used to retrain the ML model. Once the ML model is retrained and validated, the retrained model is deployed back to the image-capturing device 120 and applied to incoming images to detect targeted objects. During the application of the retrained model, additional user interactions are obtained and converted to additional training examples, which can be used to retrain the model again. The cycle of user feedback, data integration, and model retraining forms a continuous training loop, gradually enhancing the model's performance as it learns from real-world applications and adaptive interactions.

The network 130 facilitates communication between the image-capturing device 120 and the cloud training system 140. The network 130 is typically the Internet, but may be any network, including but not limited to a LAN, a MAN, a WAN, a mobile wired or wireless network, a cloud computing network, a private network, or a virtual private network.

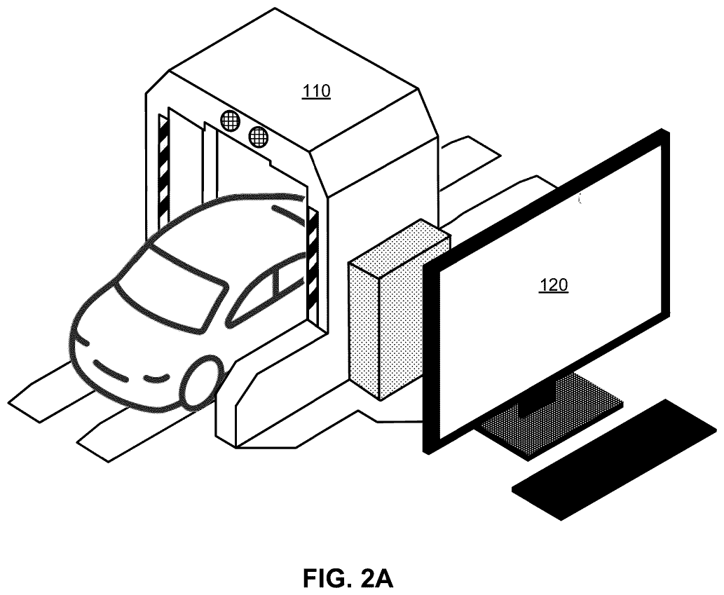

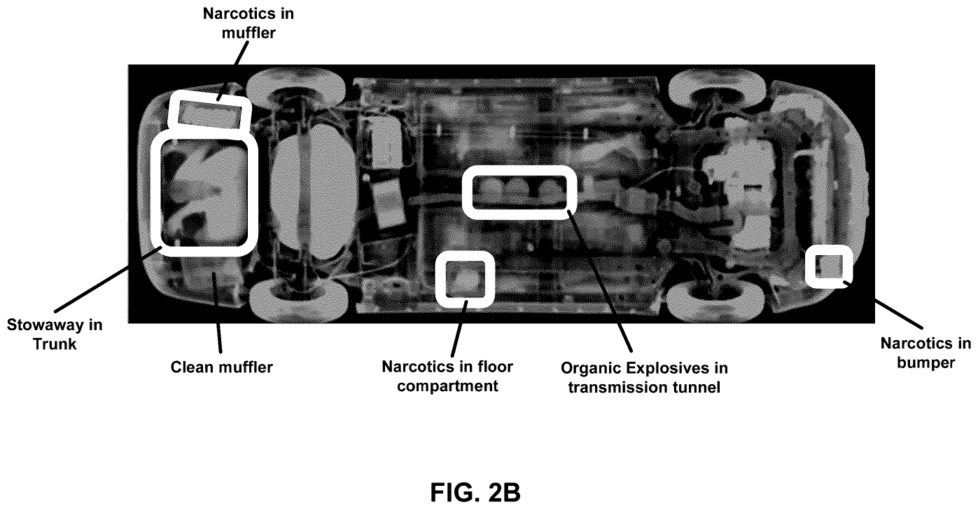

FIG. 2A illustrates an example of a vehicle scanning system at a checkpoint, in accordance with one or more embodiments. A car is shown driving through a scanning device. This scanner is connected to a computer system (e.g., image-capturing device 120) with a monitor displaying a scanning image of the car and a warning alert at the rear of the car, highlighting a detected object. Upon receiving the warning alert, the vehicle may be subject to a manual inspection. If no issues are detected, the vehicle can proceed through the checkpoint with minimal disruption.

FIG. 2B illustrates an example X-ray scan of a vehicle in a top down view in accordance with one or more embodiments. The X-ray scan includes several bounding boxes with labels, indicating areas where targeted objects have been detected. The labels provide information on what each highlighted area supposedly contains. The left rear of the vehicle shows a bounding box around the trunk area, indicating the presence of a stowaway. One of the mufflers is highlighted with a bounding box, indicating the presence of hidden narcotics. Another muffler is highlighted with a bounding box, as a comparison or control reference. A section of the vehicle's floor is highlighted with a bounding box, indicating a hidden compartment containing narcotics. A central area of the vehicle's undercarriage is highlighted with a bounding box, indicating explosives hidden in the transmission tunnel. The rear bumper area is also highlighted, indicating another location where narcotics are hidden.

### Example Object Detection System

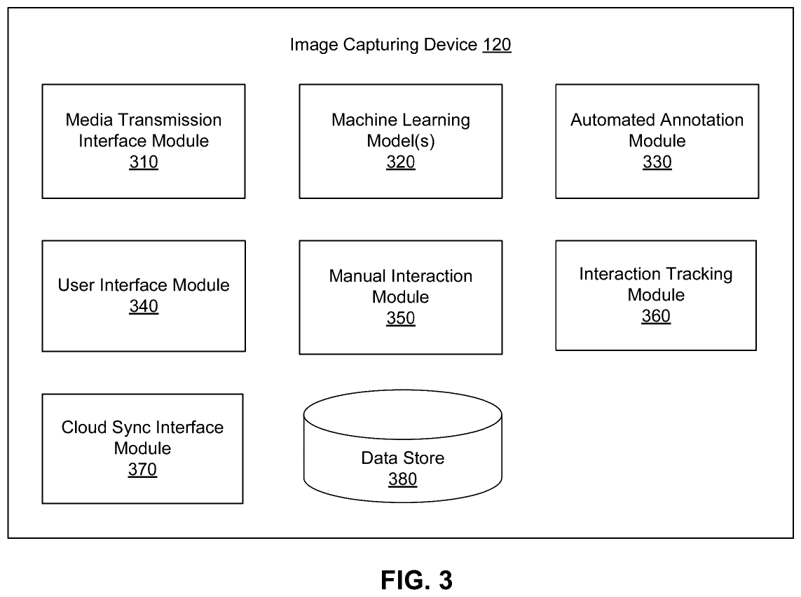

FIG. 3 illustrates an example architecture of an image-capturing device 120, in accordance with one or more embodiments. The image-capturing device 120 includes a media transmission interface module 310, one or more ML model(s) 320, an automated annotation module 330, a user interface module 340, a manual annotation module 30, an interaction tracking module 360, a cloud sync interface module 370, and a data store 390.

The media transmission interface module 310 facilitates the transfer of media data, such as video streams or images, from the imaging system 110 to the image-capturing device 120. In some embodiments, the media transmission interface module 310 includes a high-definition multimedia interface (HDMI) configured to receive raw video feeds from the imaging system 110 that supports HDMI output. Alternatively, or in addition, the media transmission interface module 310 may include a display port (DP), a USB-C connector, a Thunderbolt 3 or 4 connector, a digital visual interface (DVI), a video graphics array (VGA), a serial digital interface (SDI), and/or ethernet, among others.

The media data may be individual still images or a video stream which is a sequence of frames. A frame is a single image in a sequence of images that make up a video stream. As described herein, the term “image” encompasses both an individual still image and a frame within a video stream, and the term “image data” or “media data” encompasses both data associated with either a still image or a video stream. In some embodiments, the video stream may be displayed to users. Alternatively, a frame or a subset of frames may be displayed to users. In some embodiments, users can select any one of the frames to be displayed.

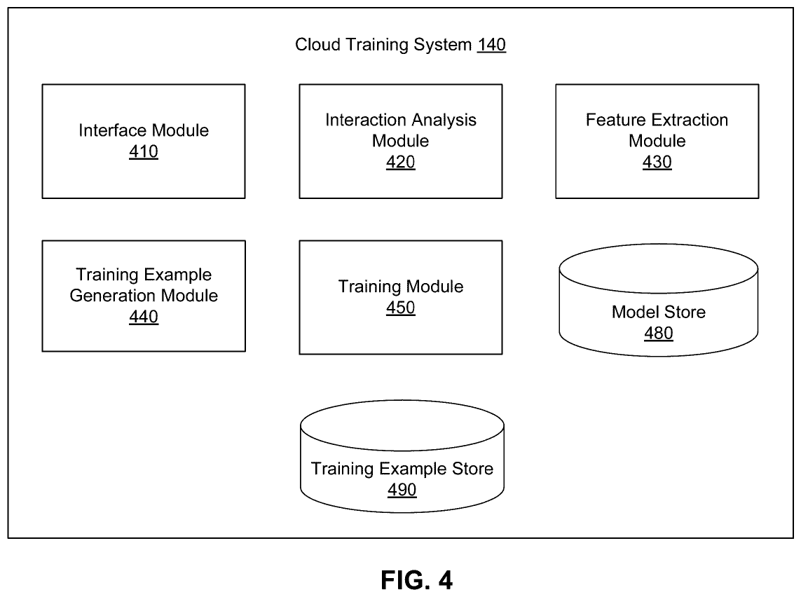

The ML model(s) 320 are configured to process incoming media to identify, classify, and/or localize objects within images or video streams. The ML model(s) 320 may be trained over a training dataset via convolutional neural networks (CNNs), region-based CNNs (R-CNNs), single-shot detectors (SSDs), recurrent neural networks (RNNs), and/or autoencoders, among others. The training dataset may include many labeled training examples, e.g., images labeled with bounding boxes where targeted objects are present. The models 320 learn from the labeled training examples to adjust the model's parameters to minimize the difference between the predicted and actual labels. In some embodiments, the models 320 are trained at a cloud computing environment, e.g., cloud training system 140, and deployed onto the image-capturing device 120. Additional details about training and retraining the ML models 320 are further described below with respect to FIG. 4.

The automated annotation module 330 is configured to annotate detected objects within the media based on the analysis conducted by the ML model(s) 320. The module 330 causes the processed images or videos with annotations to be displayed on a graphical user interface. In some embodiments, a location of an object within an image is annotated as a bounding box. Additional labels may be added to detected objects, such as what type of object has been detected. For a security system, labels might include “weapon”, “explosive”, “contraband”, and/or “human”, among others; in a medical imaging system, labels may include “tumor”, “cyst”, “fracture,” and/or “calcification”, among others. In some embodiments, the labels also include the model's confidence in the accuracy of detection. For example, a numerical value between 0 and 1 (e.g., 0.95%) indicates 95% confidence in the detection of an object. In some embodiments, the labels may also include time-related information, e.g., timestamps showing when an object was detected in a video, and a duration for how long an object was visible. In some embodiments, the labels also include the level of threat or priority, e.g., “high risk”, “medium risk”, or “low risk”. In some embodiments, the labels may further include suggested actions to be taken based on the detection, e.g., “inspect”, “alert”, or “further analysis needed”. In some embodiments, automated annotation module 330 generates labels based on predefined rules or learned patterns.

In some embodiments, the ML model(s) 320 include one or more classifiers trained to identify instances of a particular object type. For each image, the classifier may output a likelihood that one or more instances of the particular object type exist within the image. the classifier may output a confidence score representative of the likelihood that the image includes an instance of the object type or may output a Boolean result of the classification (e.g., “true” if the image includes an instance of the object type or “false” if not). In some embodiments, a classifier may detect multiple instances of the object type within an image.

The user interface module 340 provides a graphical user interface to users, allowing the users to view, interact with, and manage the detection results. The graphical user interface displays processed images or videos with annotations. In some embodiments, the graphical user interface may also include tools for adjusting settings, reviewing historical data, and/or exporting information.

The manual interaction module 350 allows users to interact with the graphical user interface to provide feedback on ML detected objects, and/or annotate additional objects that the ML model missed. For example, for each ML-detected object, users may confirm or deny the accuracy of the ML detection. In some embodiments, users can mark detected objects as “correct” or “incorrect,” providing direct feedback on whether the object was accurately identified or is a false positive. In some cases, users can also adjust the bounding boxes or annotations if they are not precisely placed, resize them, or move them to better fit the actual object. In some embodiments, users may be able to rate the confidence or quality of detection on a scale (e.g., from “poor” or “excellent”) or provide more nuanced commentary on what aspects of the detection were well-handled and which were lacking. In some embodiments, users may also be allowed to draw irregularly shaped segmentation masks to identify irregularly shaped objects. In some cases, users can also add annotations for objects that the ML models failed to detect (false negatives). In some embodiments, users can also label additional attributes to the detected objects that the ML model may not initially include.

The interaction tracking module 360 tracks and records user interactions with the image-capturing device 120. In some embodiments, the interaction tracking module 360 tracks all annotations made by a user, including creating, modifying, or deleting annotations, such as drawing bounding boxes, adding segmentation masks, or labeling attributes. In some embodiments, the exact times, types, and details of these annotations are also logged. In some embodiments, the interaction racking module 360 also captures user response to the accuracy of objects detected by ML models, including users'confirmation or rejection of detections along with the specific type of objects involved, and the timestamps. The interaction tracking module 360 also tracks corrections made to the model's predictions, including adjustments to the size, position, or classification of detected objects by users. In some embodiments, the interaction tracking module 360 may also track how users navigate through the system, such as zooming, panning, and/or switching between images or video feeds. In some embodiments, the interaction tracking module 360 may also track the usage of different toolsets within the interface, such as search functions and filters, along with time spent on various actions and outcomes of these actions.

Cloud sync interface module 370 manages the synchronization of data between the image-capturing device 120 and cloud training system 140. In some embodiments, the raw images received from the imaging system 110, the annotated images by the ML models, and user interactions with the annotated images are stored in data store 390 and transmitted to the cloud training system 140, which backs up the received data. The cloud training system 140 also generates additional training examples based on the received data and retrains the ML models based on the additional training examples. The retrained ML models are then deployed onto the image-capturing device 120 via the cloud sync interface module 370 and used to detect targeted objects from incoming media data.

FIG. 4 illustrates an example architecture of a cloud training system 140 in accordance with one or more embodiments. The cloud training system 140 includes an interface module 410, an interaction analysis module 420, a feature extraction module 430, a training example generation module 440, a training module 350, a model store 380, and a training example store 380.

The interface module 410 is configured to exchange data with the image-capturing device 120 via application programming interfaces (APIs) and/or various communication protocols. The APIs may provide a set of rules for requesting data and/or triggering actions between the cloud training system 140 and the image-capturing device 120. The APIs may include (but are not limited to) RESTful APIs, which allow devices to request data using standard HTTP methods, and/or gRPC, which offers a low-latency alternative to RESTful APIs using HTTP/2 as the transport protocol.

The interaction analysis module 420 analyzes user interactions with the media data received from the imaging system and ML-detected objects to assess the relevance and quality of the interaction data. In some embodiments, before the ML models are trained, the interaction data mostly includes user interactions with raw images. After the ML models are trained and deployed onto the image-capturing device 120, the interaction data may further include (but are not limited to) accuracy feedback, correction of model predictions, annotation interactions, and/or navigation and system usage. Accuracy feedback may include (but is not limited to) users'responses to the accuracy of objects detected by the ML models, including whether they confirm (agree) or reject (disagree) with the detection. Correction of model predictions may include (but is not limited to) corrections made to the model's predictions, such as changes to the size, position, or classification of the detected objects. Annotation interactions may include (but are not limited to) users' drawing new bounding boxes, segmentation masks, or applying other types of annotations to images or videos. Navigation and system usage data may include (but is not limited to) how users navigate through the system, such as using zoom and pan functions or switching between different images or video feeds, engagement with various tools within the system interface, such as utilizing search functions, applying filters, and other features. In some embodiments, the user interaction data may also include user interaction patterns, such as how users interact with the entire system, workflows, and preferences. This additional data may help in identifying user needs and potential areas for system improvement. The interaction analysis module 420 identifies relevant interaction data and/or filters out irrelevant data or noise (e.g., accidental clicks, redundant actions or idle time) and provides the relevant interaction data to the feature extraction module 430.

The feature extraction module 430 is configured to extract features from the relevant user interaction data. In some embodiments, the feature extraction module 430 categorizes user feedback into types such as confirmations and rejections. In some embodiments, the extents of corrections (e.g., significant adjustments to bounding boxes or minor tweaks) are measured to categorize some of the corrections into confirmation, and the others into rejections.

The training example generation module 440 is configured to convert the features into additional training examples. In some embodiments, for supervised learning, each training example includes a feature vector and an associated label. A collection of extracted features for a particular detection instance is labeled with an outcome determined by user feedback. For instance, if a user confirms an initial bounding box detected by ML models, the bounding box is labeled as a positive example. On the other hand, if a user rejects an initial bounding box detected by ML models, the bounding box is labeled as a negative example. As another example, if a user corrects a bounding box significantly, the initial detection could be labeled as a negative example, and the corrected version is labeled as a positive example. The additional training examples are stored in the training example store 490.

The training module 450 is configured to train and retrain the ML models using the training examples. The training module 450 may use supervised learning, unsupervised learning, or reinforcement learning to adjust and refine the models'parameters based on the training examples. Various ML techniques may be used to train the ML models, such as (but not limited to) CNNs, faster R-CNN, YOLO (You Only Look Once), and/or SSD. The model architecture may be configured to define a number of layers, activation functions, and any hyperparameters based on the type of objects that are to be detected. The models learn to recognize the features of the objects by adjusting their parameters through a process of feed forward calculations and/or backpropagation of errors. The models use a loss function to measure the accuracy of the model's predictions against the true labels. In some embodiments, a combination of loss functions might be used, one for classification (e.g., cross-entropy loss) and one for bounding box regression (e.g., smooth L1 loss). The training examples may be divided into two subsets, one for training, and the other for validation. The trained model over the training dataset is validated over the validation dataset that was not used during training to monitor the model's performance and avoid overfitting. In some embodiments, the model hyperparameters may also be adjusted based on validation results to find the best settings for learning rate, batch size, number of epochs, etc. The model performance may also be analyzed via a confusion matrix to understand the types of errors the model is making, such as misclassifications or incorrect localizations. Once the model achieves satisfactory accuracy and reliability, the model is stored in the model store 480 and deployed onto the image-capturing device 120 where it can begin detecting objects in newly received, unseen images or video streams.

### Example Loop Training Process

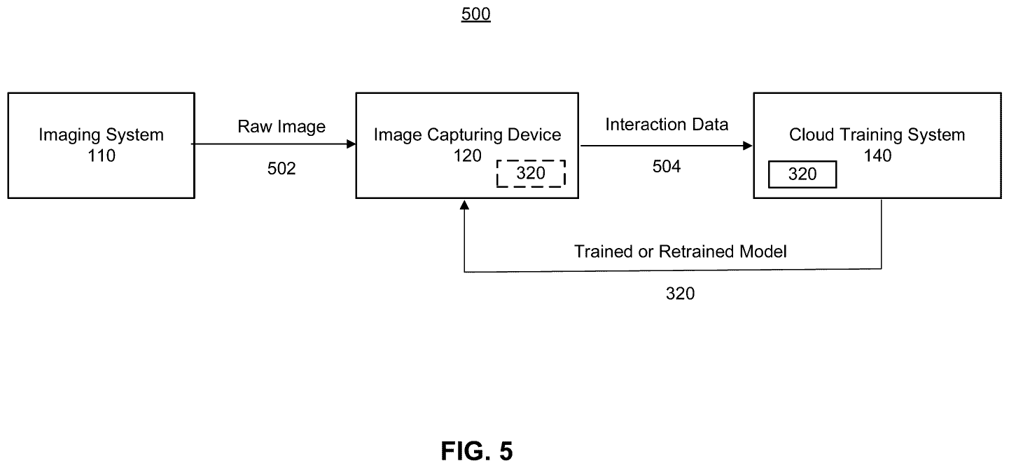

FIG. 5 illustrates a loop training process 500 in accordance with one or more embodiments. As illustrated, image system 110 is a source of raw images 502. For example, image system 110 may be a backscatter scanner at a border crossing or a medical imaging device. The raw images 502 are transmitted from the imaging system 110 to the image-capturing device 120. The raw images are presented to users, who may interact with the annotated images. The interaction data is recorded and transmitted to a cloud training system 140. The cloud training system 140 converts the interaction data into training examples, and trains one or more ML models 320 over the training examples. The one or more ML models 320 are trained to identify targeted objects in any given images. The ML model 320 is then deployed onto the image-capturing device 120.

Responsive to receiving new raw images from the imaging system 110, the image-capturing device 120 applies the one or more ML models 320 to the newly received raw images to automatically identify targeted objects and annotate them on the raw images. The annotated images are presented for display to users, who may interact with the annotated images. The interactions may include confirming or rejecting the ML-identified objects or adding additional annotations, indicating additional objects that are missed by the ML models. The interaction data 504 associated with user interactions with the annotated images is transmitted to the cloud training system 140. The cloud training system 140 converts the interaction data into additional training examples, which are then used to retrain the ML model. The retrained ML models 320 are then deployed onto the image-capturing device 120.

Again, the image-capturing device 120 applies the retrained ML model 320 to newly received raw images from the imaging system 110 to identify and annotate targeted objects. The users may interact with the annotated images to generate interaction data 504, which is then transmitted to the cloud training system 140. The cloud training system 140 generates additional training examples based on the interaction data 504, which can then be used to retrain the ML models 320. The retrained ML models 320 are then deployed onto the image-capturing device 120. This process may continue such that the ML models 320 continue to improve based on newly obtained interaction data. In some embodiments, the process may repeat as many times as necessary until the performance improves to a target level. Alternatively, or in addition, this training cycle can be set to recur at regular intervals or once a certain amount of interaction data has been collected. This way, the ML models continue to improve based on the newly accumulated interaction data.

### Example Process Flows

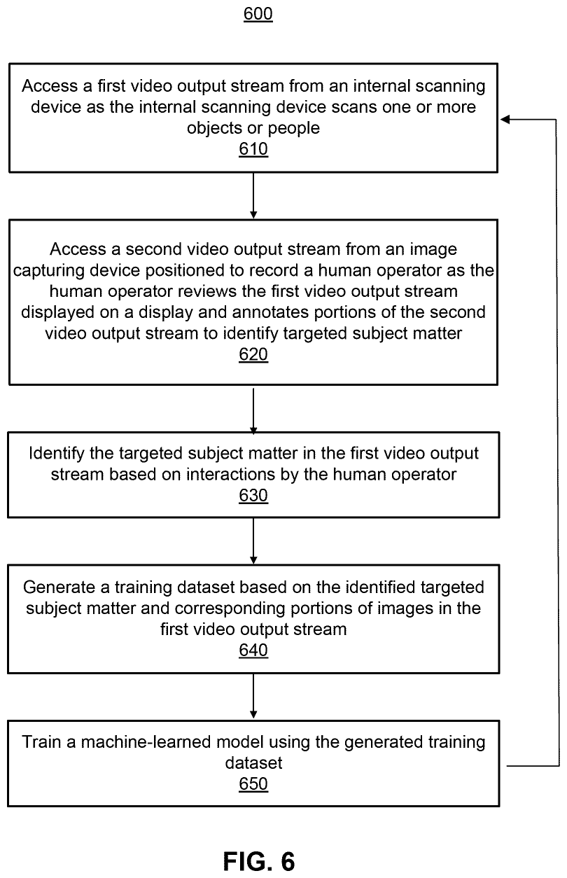

FIG. 6 is a flowchart of an example method 600 for training an ML model based on tracking user interactions with images received from imaging systems, in accordance with one or more embodiments. The method 600 may be performed by one or more processors of a system, including the image-capturing device 120 and/or cloud training system 140. In some embodiments, the method 600 may include fewer or more steps illustrated in FIG. 6. The steps in method 600 may be performed in any sequence.

The system accesses 610 a first video output stream from an internal scanning device as the internal scanning device scans one or more objects or people. In some embodiments, the internal scanning device may be an MRI scanner, an X-ray scanner, a CAT scanner, or a backscatter scanner. In some embodiments, the internal scanning device may be a backscatter scanner at a border crossing or a checkpoint. Alternatively, the internal scanning device may be a medical imaging device, e.g., a CAT scanner, an MRI scanner, or an ultrasound scanner. Such types of internal scanning devices are often proprietary machines that lack APIs or interfaces for other systems to directly access their data. Users may be able to review output of media data generated by the internal scanning device via an internal software or internal hardware coupled to the internal scanning device. Even though it is difficult to directly obtain the media data, the internal scanning device may include a media interface that allows capturing of the video stream generated by the device and user interaction with the video stream.

In some embodiments, an image-capturing device (e.g., image-capturing device 120) receives the first video output stream and presents the first video output stream on a display to human operators. The human operator can review and interact with the first video output stream to identify targeted subject matter. The image-capturing device captures a second video output stream which records the human operator's interactions with portions of the first video output stream.

The system accesses 620 the second video output stream from the image-capturing device and identifies 630 the targeted subject matter in the first video output stream based on interactions by the human operator with the portions of the first video output stream. For example, the human operator can draw bounding boxes around targeted objects within frames of the first video output stream, assign predefined labels (e.g., “weapon”, or “drug”) to the bounding boxes, and/or label additional attributes or properties to the targeted objects or bounding boxes (e.g., “high”, “medium”, or “low” confidence levels). In some embodiments, the human operator can create pixel-wise contours (e.g., a tumor in medical imaging) that precisely outline the boundaries of a targeted object within a frame of the first video output stream.

The system generates 640 a training dataset based on the identified targeted subject matter and corresponding portions of images in the first video output stream. The system trains 650 an ML model using the generated training dataset. The ML model is trained to identify the targeted subject matter in video streams from the internal scanning device. This process can repeat as many times as necessary to retrain the model based on additional user interactions over incoming video streams until the model is sufficiently accurate.

The trained ML model may be applied to the incoming video output stream from the internal scanning device to identify targeted objects and annotate portions of the video output stream. A human operator may further provide feedback over ML-generated annotations.

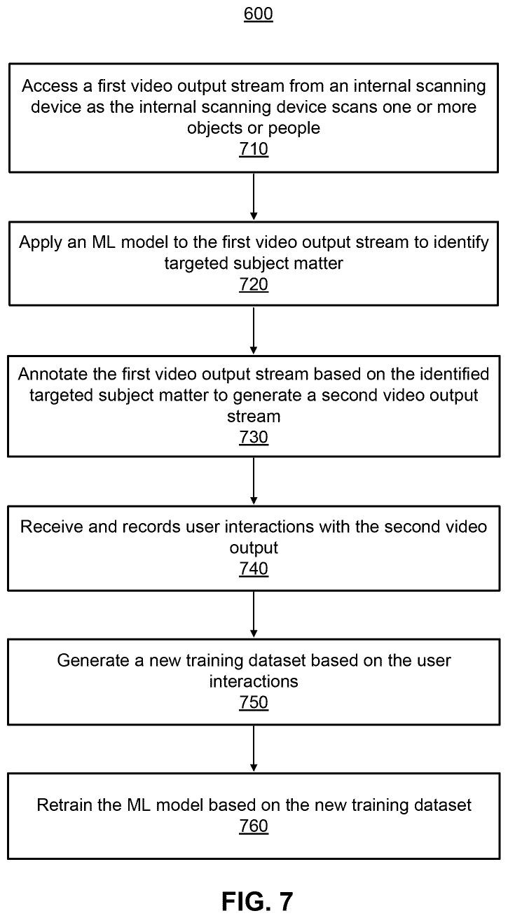

FIG. 7 is a flowchart of a method 700 for retraining an ML model based on tracking user interactions with images received from imaging systems, in accordance with one or more embodiments. The method 700 may be performed by one or more processors of a system, including the image-capturing device 120 and/or cloud training system 140. In some embodiments, the method 700 may include fewer or more steps illustrated in FIG. 7. The steps in method 700 may be performed in any sequence.

The system accesses 710 a first video output stream from an internal scanning device as the internal scanning device scans one or more objects or people. This internal scanning device, such as an MRI scanner, CAT scanner, or X-ray scanner, captures real-time images and videos of the objects being scanned, providing raw media data that serve as the initial input for further analysis.

The system applies 720 an ML model to the first video output stream to identify targeted subject matter. The ML model may be trained based on method 600 described above. The ML model processes the video stream using algorithms like convolutional neural networks (CNNs) to detect and classify objects within the stream based on previous training. The model identifies specific features and patterns corresponding to known objects, such as medical anomalies or security threats.

The system annotates 730 the first video output stream based on the identified targeted subject matter to generate a second video output stream. This may include overlaying visual markers, such as bounding boxes, labels, or segmentation masks, on the video to highlight the detected objects. These annotations help human operators or automated systems to easily recognize and understand the locations and types of objects identified by the ML model.

The system receives and records 740 user interactions with the second video output. As users interact with the annotated video, their actions—such as adjusting annotations, confirming or rejecting detections, and adding additional labels—are captured.

The system generates 750 a new training dataset based on the user interactions. For example, every instance where a user modifies an ML-generated annotation or adds a new annotation can be used to generate a training example. For instance, if a user confirms an ML-generated annotation, that annotation and corresponding image may be used as a positive training example. On the other hand, if the user rejects an ML-generated annotation, that annotation and corresponding image may be used as a negative training example.

The system retrains 760 the ML model based on the new training dataset. The retrained model may be deployed onto the image-capturing device 120 again to process incoming video streams, and a user may interact with the processed incoming video streams to provide feedback on ML-generated annotations. The user interactions may then be used to generate additional training datasets, and the ML model may be retrained again based on the new training datasets. This process can be repeated as often as needed until the ML model's accuracy meets a predetermined threshold. Alternatively, or additionally, the process can be set to recur at regular intervals or each time a sufficient amount of user interaction data is collected. Consequently, the accuracy of the ML model continues to improve.

### Computer Architecture

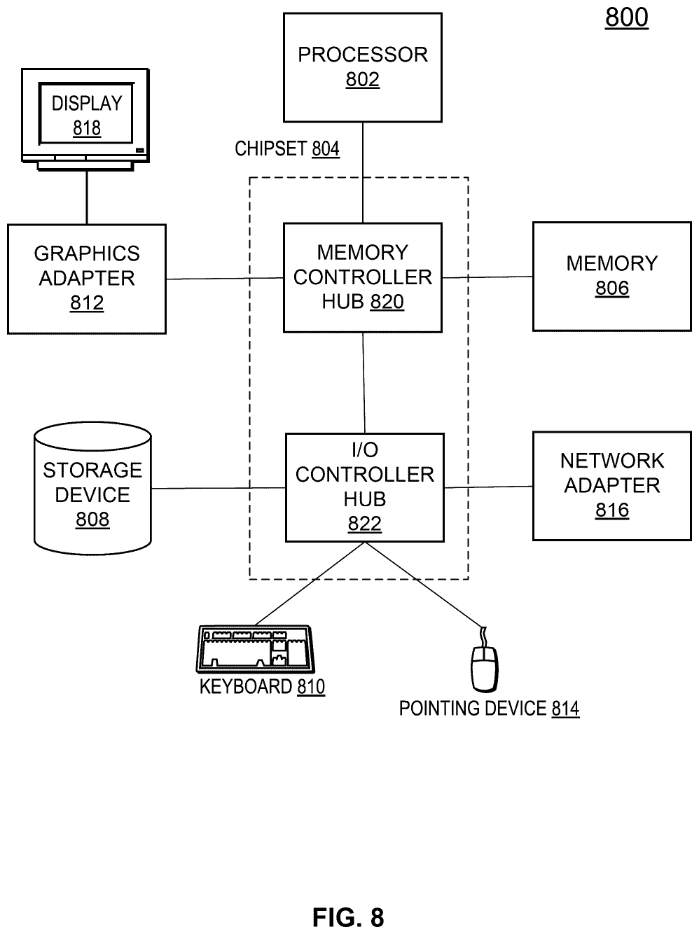

FIG. 8 is a high-level block diagram of a computer 800 for implementing different entities illustrated in FIG. 1. The computer 800 includes at least one processor 802 coupled to a chipset 804. Also coupled to the chipset 804 are a memory 806, a storage device 808, a keyboard 810, a graphics adapter 812, a pointing device 814, and a network adapter 816. A display 818 is coupled to the graphics adapter 812. In one embodiment, the functionality of the chipset 804 is provided by a memory controller hub 820 and an I/O controller hub 822. In another embodiment, the memory 806 is coupled directly to the processor 802 instead of the chipset 804.

The storage device 808 is any non-transitory computer-readable storage medium, such as a hard drive, compact disk read-only memory (CD-ROM), DVD, or a solid-state memory device. The memory 806 holds instructions and data used by the processor 802. The pointing device 814 may be a mouse, track ball, or other type of pointing device, and is used in combination with the keyboard 810 to input data into the computer system 800. The graphics adapter 812 displays images and other information on the display 818. The network adapter 816 couples the computer system 800 to the network 130.

As is known in the art, a computer 800 can have different and/or other components than those shown in FIG. 8. In addition, the computer 800 can lack certain illustrated components. For example, the computer acting as the online system can be formed of multiple blade servers linked together into one or more distributed systems and lack components such as keyboards and displays. Moreover, the storage device 808 can be local and/or remote from the computer 800 (such as embodied within a storage area network (SAN)).

As is known in the art, the computer 800 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 808, loaded into the memory 806, and executed by the processor 802.

### Alternative Embodiments

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

It is to be understood that the figures and descriptions have been simplified to illustrate elements that are relevant for a clear understanding of the present invention, while eliminating, for the purpose of clarity, many other elements found in a typical online system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the various embodiments. This description should be read to include one or at least one and the singular also includes the plural unless it is obvious that it is meant otherwise.

Upon reading this disclosure, those of skill in the art will appreciate still additional alternative designs for a unified communication interface providing various communication services. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed:

1. A computer-implemented method, the method comprising:
accessing a first video output stream from an internal scanning device as the internal scanning device scans one or more objects or people;
accessing a second video output stream from an image-capturing device configured to record a human operator as the human operator reviews the first video output stream displayed on a display and interacts with portions of the first video output stream to identify targeted subject matter, which in turn generates the second video output stream;
identifying the targeted subject matter in the first video output stream based on interactions by the human operator with the portions of the first video output stream;
generating a training dataset based on the identified targeted subject matter and corresponding portions of images in the first video output stream; and
training a machine-learned model using the generated training dataset, the machine-learned model trained to identify the targeted subject matter in video streams from internal scanning devices.

2. The computer-implemented method of claim 1, wherein the internal scanning device is one of an MRI scanner, an X-ray scanner, a CAT scanner, or a backscatter scanner.

3. The computer-implemented method of claim 1, wherein the internal scanning device is an X-ray scanner configured to scan vehicles at a security checkpoint to identify at least one of the following targeted subject matters: drugs, weapons, or explosives.

4. The computer-implemented method of claim 1, further comprising:
applying the machine-learned model to a target video output stream from a target internal scanning device to identify the targeted subject matter;
modifying the target video output stream to include indications of the identified targeted subject matter; and
displaying the modified target video output stream.

5. The computer-implemented method of claim 4, further comprising:
receiving an indication from a target human operator that the identified target subject matter is a false positive;
generating a new training dataset based on the indication; and
retraining the machine-learned model based on the new training dataset.

6. The computer-implemented method of claim 4, further comprising:
receiving an indication from a target human operator that confirms the identified target subject matter as correct;
generating a new training dataset based on the indication; and
retraining the machine-learned model based on the new training dataset.

7. The computer-implemented method of claim 4, further comprising:
receiving an indication from a target human operator that the identified target subject matter within the modified target video output stream was missed;
generating a new training dataset based on the indication; and
retraining the machine-learned model based on the new training dataset.

8. The computer-implemented method of claim 4, further comprising:
receiving an indication from a target human operator that modifies the identified target subject matter;
generating a new training dataset based on the indication; and
retraining the machine-learned model based on the new training dataset.

9. A non-transitory computer-readable storage medium storing executable computer instructions that when executed by a hardware processor are configured to cause the hardware processor to perform steps comprising:
accessing a first video output stream from an internal scanning device as the internal scanning device scans one or more objects or people;
accessing a second video output stream from an image-capturing device configured to record a human operator as the human operator reviews the first video output stream displayed on a display and interacts with portions of the first video output stream to identify targeted subject matter, which in turn generates the second video output stream;
identifying the targeted subject matter in the first video output stream based on interactions by the human operator with the portions of the first video output stream;
generating a training dataset based on the identified targeted subject matter and corresponding portions of images in the first video output stream; and
training a machine-learned model using the generated training dataset, the machine-learned model trained to identify the targeted subject matter in video streams from internal scanning devices.

10. The non-transitory computer-readable storage medium of claim 9, wherein the internal scanning device is one of an MRI scanner, an X-ray scanner, a CAT scanner, or a backscatter scanner.

11. The non-transitory computer-readable storage medium of claim 9, wherein the internal scanning device is an X-ray scanner configured to scan vehicles at a security checkpoint to identify at least one of the following targeted subject matters: drugs, weapons, or explosives.

12. The non-transitory computer-readable storage medium of claim 9, wherein the hardware processor is further caused to:
apply the machine-learned model to a target video output stream from a target internal scanning device to identify the targeted subject matter;
modify the target video output stream to include indications of the identified targeted subject matter; and
display the modified target video output stream.

13. The non-transitory computer-readable storage medium of claim 12, wherein the hardware processor is further caused to:
receive an indication from a target human operator that the identified target subject matter is a false positive;
generate a new training dataset based on the indication; and
retrain the machine-learned model based on the new training dataset.

14. The non-transitory computer-readable storage medium of claim 12, wherein the hardware processor is further caused to:
receive an indication from a target human operator that confirms the identified target subject matter as correct;
generate a new training dataset based on the indication; and
retrain the machine-learned model based on the new training dataset.

15. The non-transitory computer-readable storage medium of claim 12, wherein the hardware processor is further caused to:
receive an indication from a target human operator that the identified target subject matter within the modified target video output stream was missed;
generate a new training dataset based on the indication; and
retrain the machine-learned model based on the new training dataset.

16. The non-transitory computer-readable storage medium of claim 12, wherein the hardware processor is further caused to:
receive an indication from a target human operator that modifies the identified target subject matter;
generate a new training dataset based on the indication; and
retrain the machine-learned model based on the new training dataset.

17. A system, comprising:
a computer processor; and
a non-transitory memory storing executable computer instructions that when executed by the computer processor are configured to cause the computer processor to perform steps comprising:
accessing a first video output stream from an internal scanning device as the internal scanning device scans one or more objects or people;
accessing a second video output stream from an image-capturing device configured to record a human operator as the human operator reviews the first video output stream displayed on a display and interacts with portions of the first video output stream to identify targeted subject matter, which in turn generates the second video output stream;
identifying the targeted subject matter in the first video output stream based on interactions by the human operator with the portions of the first video output stream;
generating a training dataset based on the identified targeted subject matter and corresponding portions of images in the first video output stream; and
training a machine-learned model using the generated training dataset, the machine-learned model trained to identify the targeted subject matter in video streams from internal scanning devices.

18. The system of claim 17, wherein the internal scanning device is one of an MRI scanner, an X-ray scanner, a CAT scanner, or a backscatter scanner.

19. The system of claim 17, wherein the internal scanning device is an X-ray scanner configured to scan vehicles at a security checkpoint to identify at least one of the following targeted subject matters: drugs, weapons, or explosives.

20. The system of claim 17, wherein the computer processor is further caused to:
apply the machine-learned model to a target video output stream from a target internal scanning device to identify the targeted subject matter;
modify the target video output stream to include indications of the identified targeted subject matter; and
display the modified target video output stream.
